(19) United States
(12) Patent Application Publication
(10) Pub. No.: US 2023/0023681 A1
(43) Pub. Date: Jan. 26, 2023

(54) POWER TOOL

(71) Applicant: Nanjing Chervon Industry Co., Ltd., Nanjing (CN)

(72) Inventors: Rui Xu, Nanjing (CN); Xiaoyong Wang, Nanjing (CN); Di Wu, Nanjing (CN)

(21) Appl. No.: 17/866,039

(22) Filed: Jul. 15, 2022

(30) Foreign Application Priority Data
Jul. 23, 2021 (CN) 202110836458.0
Jul. 23, 2021 (CN) 202121696269.X
Jul. 23, 2021 (CN) 202121696379.6

(51) Int. Cl. B23B 31/12; B25B 23/00

(52) U.S. Cl. CPC B23B 31/1253; B25B 23/0035; B25B 21/02

(57) ABSTRACT

A power tool includes a chuck device for clamping a working component. The chuck device includes a locking mechanism, an operation member, a connection shaft, a driving assembly, and a stopper member. The locking mechanism implements a locking function. The operation member is operable to allow the locking mechanism to leave a locking position and is detachably connected to the connection shaft. The driving assembly drives the locking mechanism to be in the locking position. The stopper member is configured to limit the driving assembly.

### RELATED APPLICATION INFORMATION

This application claims the benefit under 35 U.S.C. § 119(a) of Chinese Patent Application No. CN 202121696379.6, filed on Jul. 23, 2021, Chinese Patent Application No. CN 202110836458.0, filed on Jul. 23, 2021, and Chinese Patent Application No. CN 202121696269.X, filed on Jul. 23, 2021, which applications are incorporated herein by reference in their entirety.

### BACKGROUND

A handheld power tool is typically fitted with various types of replaceable working heads. Since the working heads need to be disassembled and replaced frequently, the tool is usually provided with a chuck for clamping a detachable working head. The working head can be clamped to or detached from a traditional chuck of the power tool only with an auxiliary tool and thus be replaced.

To replace the working head with greater convenience and simplify clamping and unlocking operations, there has been a power tool in the related art, which has a chuck convenient for a user to operate with a single hand. However, the chuck for quick clamping in the related art has the problems of a complicated manufacturing process and a high maintenance cost.

### SUMMARY

A power tool includes a housing, an output device capable of driving a working component, and a chuck device for clamping the working component. The chuck device includes a locking mechanism having a locking position in which the working component is locked. The chuck device further includes an operation member, a connection shaft, a driving assembly, and a stopper member. The operation member is operable to allow the locking mechanism to leave the locking position. The connection shaft is used for connecting the output device to the operation member, where the operation member is detachably connected to the connection shaft. The driving assembly is disposed inside the operation member, moves along a first direction with respect to the connection shaft, and is capable of driving the locking mechanism to be in the locking position. The stopper member is connected to the operation member and configured to limit the driving assembly and prevent the driving assembly from moving out from inside the operation member along the first direction.

In some examples, the driving assembly includes a biasing element and a pushing member, where the pushing member abuts against the locking mechanism, and the biasing element is capable of providing a biasing force for maintaining the locking mechanism in the locking position and pushing the locking mechanism to be in the locking position.

In some examples, the locking mechanism is disposed inside the operation member and mounted to the operation member along a third direction.

In some examples, the operation member includes a through hole for the locking mechanism to pass through.

In some examples, the locking mechanism is sphere.

In some examples, the chuck device further includes a blocking element. The blocking element is disposed at an end of the operation member, where a distance exists between the blocking element and an end surface of the operation member, and when the locking mechanism are disengaged from the locking position the blocking element limits a distance by which the operation member moves to disengage the locking mechanism from the locking position.

In some examples, the chuck device further includes a limiting member, where the limiting member includes a first limiting portion and a second limiting portion, the second limiting portion abuts against the locking mechanism when the locking mechanism is in the locking position, and the first limiting portion allows the locking mechanism to leave the locking position when the locking mechanism is disengaged from the locking position.

In some examples, the limiting member further includes an incline which connects the first limiting portion to the second limiting portion.

In some examples, the limiting member prevents the locking mechanism from moving out from inside the operation member along the third direction.

In some examples, the connection shaft forms a connection cavity where the working component is mounted, where the connection cavity extends along an axial direction of the connection shaft.

In some examples, the connection shaft forms a mounting hole communicating with the connection cavity, and the locking mechanism is configured to partially pass through the mounting hole and is movable along a second direction with respect to the mounting hole.

In some examples, the mounting hole extends along the first direction and the locking mechanism slides in the mounting hole along the first direction.

In some examples, a gap exists between the operation member and the connection shaft, and the driving assembly is disposed in the gap.

In some examples, the height of the gap is less than the diameter of each of the locking mechanism.

In some examples, the working component includes recess portion, where the locking mechanism is partially inserted into the recess portion when the working component is mounted to the chuck device.

A power tool includes a housing, an output device capable of driving a working component, and a chuck device for clamping the working component. The chuck device includes a locking mechanism having a locking position in which the working component is locked. The chuck device further includes an operation member and a connection shaft. The operation member is operable to allow the locking mechanism to leave the locking position. The connection shaft is used for connecting the output device to the operation member, where the operation member is detachably connected to the connection shaft.

A power tool includes a housing, an output device capable of driving a working component, and a chuck device for clamping the working component. The chuck device includes a locking mechanism having a locking position in which the working component is locked. The chuck device further includes an operation member, a connection shaft, a driving assembly, and a stopper member. The operation member is operable to allow the locking mechanism to leave the locking position. The connection shaft is used for connecting the output device to the operation member, where the locking mechanism connects the connection shaft to the operation member. The driving assembly is disposed inside the operation member and used for driving the locking mechanism to be in the locking position. The stopper member is detachably connected to the operation member and configured to limit the driving assembly and prevent the driving assembly from moving out from inside the operation member.

In some examples, the stopper member is a C-ring connected to the inner wall of the operation member.

In some examples, the stopper member moves synchronously with the operation member with respect to the connection shaft.

In some examples, a blocking element mounted at an end of the connection shaft is further included, where the blocking element is detachably connected to the connection shaft, a distance exists between the blocking element and an end surface of the operation member, and the blocking element limits a moving distance of the stopper member.

### BRIEF DESCRIPTION OF DRAWINGS

FIG. 1 is a structural view of a power tool according to a first example of the present application;

FIG. 2 is a structural view of a chuck assembly when a working component is locked to the power tool shown in FIG. 1, where locking devices are in a locking position;

FIG. 3 is a sectional view of the chuck assembly in FIG. 2 in the present application;

FIG. 4 is a structural view of a chuck assembly when a working component is detached from the power tool shown in FIG. 2 in the present application, where locking devices are disengaged from a locking position;

FIG. 5 is a structural view of the chuck assembly of the power tool shown in FIG. 2 in the present application during its manufacturing and assembly;

FIG. 6 is an exploded view of FIG. 5 of the present application;

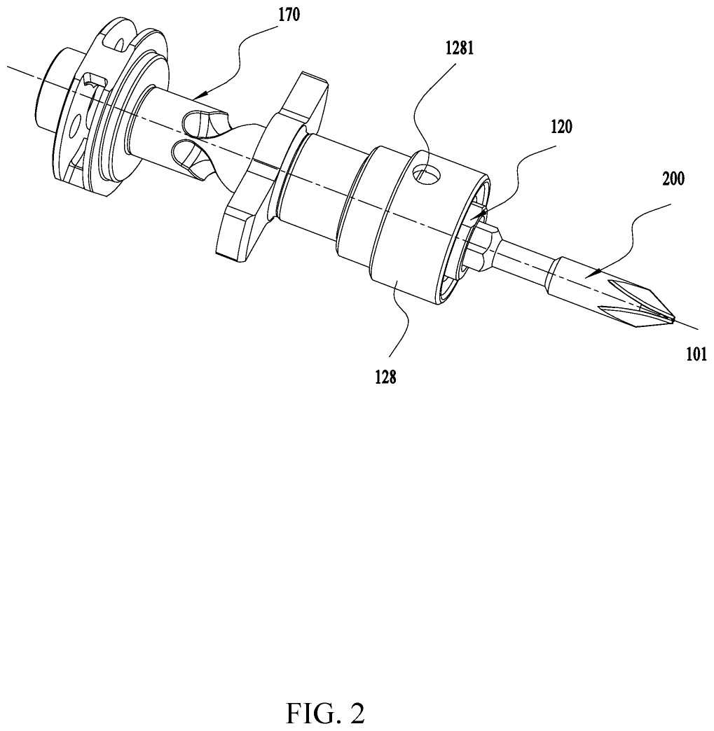

FIG. 0.7 is a structural view of part of the chuck assembly of the power tool shown in FIG. 2 in the present application;

FIG. 8 is a structural view of an operation member of the chuck assembly of the power tool shown in FIG. 2 in the present application;

FIG. 9 is a structural view of a blocking element of the chuck assembly of the power tool shown in FIG. 2 in the present application;

FIG. 10 is a structural view of a chuck assembly when a working component is not mounted to a power tool according to a second example of the present application;

FIG. 11 is a sectional view of the chuck assembly shown in FIG. 10;

FIG. 12 is a structural view of a chuck assembly when a working component is locked to the power tool shown in FIG. 10 in the present application, where locking devices are in locking position;

FIG. 13 is a sectional view of the chuck assembly shown in FIG. 12;

FIG. 14 is a sectional view of a chuck assembly when a working component is unlocked from the power tool shown in FIG. 10 in the present application, where locking devices are in release positions;

FIG. 15 is a structural view of a locking device shown in FIG. 10; and

FIG. 16 is a plane view of a locking device shown in FIG. 10.

### DETAILED DESCRIPTION

The present application is described below in detail in conjunction with drawings and examples.

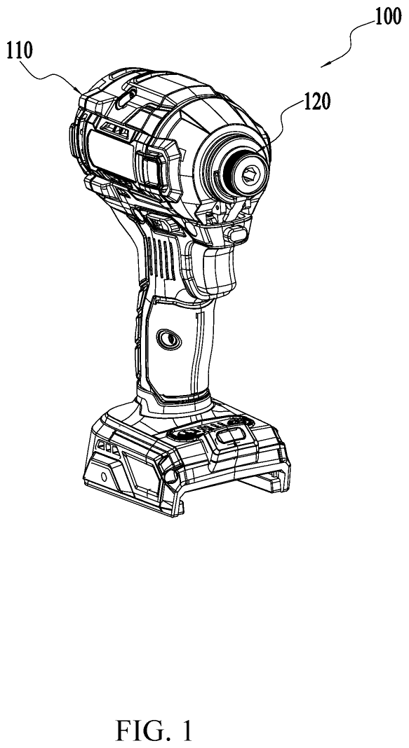

FIG. 1 is a schematic view of a power tool in the present application. The power tool is a handheld power tool. The handheld power tool 100 is a rotary impact tool, such as an impact screwdriver or an impact wrench.

Referring to FIGS. 1 and 2, the handheld power tool 100 includes a housing 110, a motor, an output device 170, and a transmission assembly. The output device 170 is used for outputting a driving force. The motor is disposed inside the housing 110, and the output device 170 is disposed at a front end of the housing 110. A working component 200 is a working head which can implement a different function, such as a screwdriver, a drill bit, and a wrench.

The motor has a motor shaft which provides rotary output. The motor includes a stator and a rotor, where the rotor can rotate about a first axis. The transmission assembly is connected to the motor and the output device 170 and configured to transmit the output of the motor to the output device 170. Specifically, the transmission assembly decelerates the rotary output of the motor shaft to perform rotary output. Optionally, the output device 170 includes an impact force generation mechanism for generating an impact force. A circuit board is electrically connected to the motor and configured to control the motor to output the driving force. The circuit board is accommodated in the housing 110.

An accommodating cavity is formed through the encirclement by the housing 110. At least part of the motor and part of the transmission assembly are accommodated in the accommodating cavity. In this example, both the motor and the transmission assembly are accommodated in the accommodating cavity formed by the housing 110 and disposed along an axial direction of the motor shaft of the motor. The transmission assembly is connected to the motor and disposed in the front of the housing 110 with respect to the motor. The motor and the transmission assembly rotate coaxially and may also rotate non-coaxially of course. The handheld power tool 100 further includes a grip and a power supply connection portion, where the grip is formed by the housing 110 for a user to grip, and the power supply connection portion is connected to a power supply for supplying power to the motor.

The handheld power tool 100 further includes the power supply for supplying electrical energy to the handheld power tool 100. Optionally, the handheld power tool 100 is powered by a direct current power supply. In this example, the handheld power tool 100 is powered by a battery pack which supplies power to the motor and circuit components on the circuit board in cooperation with a corresponding power supply circuit. It is to be understood by those skilled in the art that the power supply is not limited to the battery pack, and circuit elements may also be powered through mains or an alternating current power supply in cooperation with the corresponding rectifier circuit, filter circuit, and voltage regulation circuit.

Referring to FIGS. 2 to 5, the handheld power tool 100 further includes a chuck device 120 for clamping and fixing the working component 200. The chuck device 120 includes a connection shaft 121 and a locking mechanism 123. The connection shaft 121 is connected to the output device 170 and forms a connection cavity 122 where the working component 200 is mounted. In this example, the connection cavity 122 extends along a first direction 101 which coincides with or is parallel to an axial direction of the output device 170.

The working component 200 includes recess portion 210. The locking mechanism 123 is partially inserted into the recess portion 210 when the working component 200 is mounted to the chuck device 120.

The locking mechanism 123 is at least partially disposed in the connection shaft 121 and has a locking position in which the working component 200 is locked. The working component 200 is inserted into the connection cavity 122 along the first direction 101 and then clamped and fixed by the chuck device 120.

The chuck device 120 further includes an operation member 128, a driving assembly 12a, and a stopper member 180. The operation member 128 is operable to allow the locking mechanism 123 to leave the locking position. The driving assembly 12a is disposed inside the operation member, moves along the first direction 101 with respect to the connection shaft 121, and can push the locking mechanism 123 to be in the locking position. The driving assembly 12a includes a biasing element 125 and a pushing member 160, where the pushing member 160 is disposed between the operation member 128 and the biasing element 125 and abuts against the locking mechanism 123, and the pushing member 160 pushes the locking mechanism 123 to be in the locking position. The biasing element 125 can provide a biasing force for maintaining the locking mechanism 123 in the locking position and pushing the locking mechanism 123 to be in the locking position. The biasing element 125 and the pushing member 160 are disposed inside the operation member, the biasing element 125 connects the pushing member 160 to the operation member 125, and the pushing member 160 pushes the locking mechanism 123 to be in the locking position.

The connection shaft 121 is disposed in front of the housing. When the locking mechanism 123 is in the locking position, the biasing element 125 pushes the pushing member 160 forward and pushes the operation member 128 backward. The biasing element 125 implements the biasing of the pushing member 160 and the limitation of the operation member 128, which can reduce not only a cost but also the size of the chuck device 120.

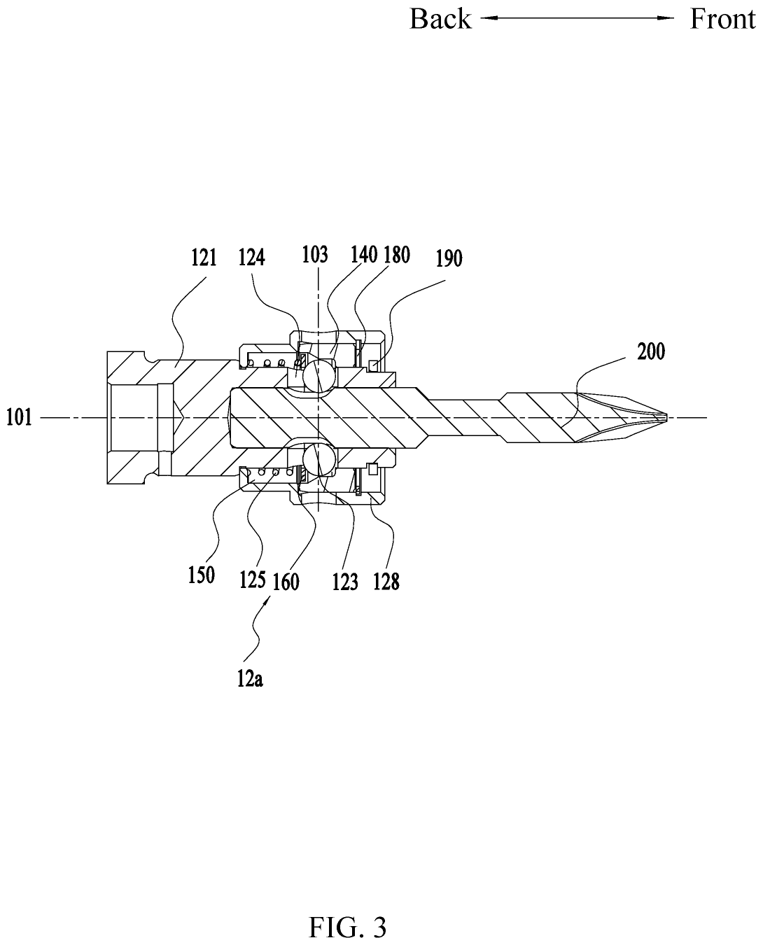

Referring to FIGS. 3 to 5, the connection shaft 121 is formed with a mounting hole 124 communicating with the connection cavity 122, and the locking mechanism 123 is configured to partially pass through the mounting hole 124 and is movable along a second direction 102 with respect to the mounting hole 124. The mounting hole 124 communicates with the connection cavity 122, and the working component 200 can be placed into the connection cavity 122. The locking mechanism 123 passing through the mounting hole 124 can partially abut against the working component 200 and lock the working component 200 through the biasing force provided by the biasing element 125.

In this example, the mounting hole 124 extends along the first direction 101, and the locking mechanism 123 slides along the first direction 101 while moving along the second direction 102.

The chuck device 120 further includes a limiting member 140 which encircles a mounting cavity for limiting the locking mechanism 123, and the mounting hole 124 is at least partially exposed to an inside of the mounting cavity 130. The limiting member 140 includes a first limiting portion 141 and a second limiting portion 142. When the locking mechanism 123 is in the locking position, the second limiting portion 142 abuts against the locking mechanism 123. When the locking mechanism 123 is disengaged from the locking position, the first limiting portion 141 abuts against the locking mechanism 123. In a direction perpendicular to the first direction 101, the first limiting portion 141 is away from the locking mechanism 123 with respect to the second limiting portion 142. In this example, the locking mechanism 123 includes a plurality of spheres. In order that the locking mechanism 123 can slide smoothly from the position where the locking mechanism 123 abuts against the second limiting portion 142 to the position where the locking mechanism 123 abuts against the first limiting portion 141, an incline 143 is disposed between the first limiting portion 141 and the second limiting portion 142.

When the first limiting portion 141 abuts against the locking mechanism 123, the locking mechanism 123 is disengaged from the locking position. Since the first limiting portion 141 is away from the locking mechanism 123 with respect to the second limiting portion 142, the locking mechanism 123 may move along the first direction 101 with respect to the connection shaft 121, thereby releasing the working component 200 from the limitation by the locking mechanism 123. When the second limiting portion 142 abuts against the locking mechanism 123, the locking mechanism 123 is in the locking position and engaged with the recess portion 210, the position of the locking mechanism 123 is limited by the limiting member 140, and the working component 200 is connected by the locking mechanism 123. Two or more locking mechanisms 123 may be provided to enhance the stability of clamping the working component 200.

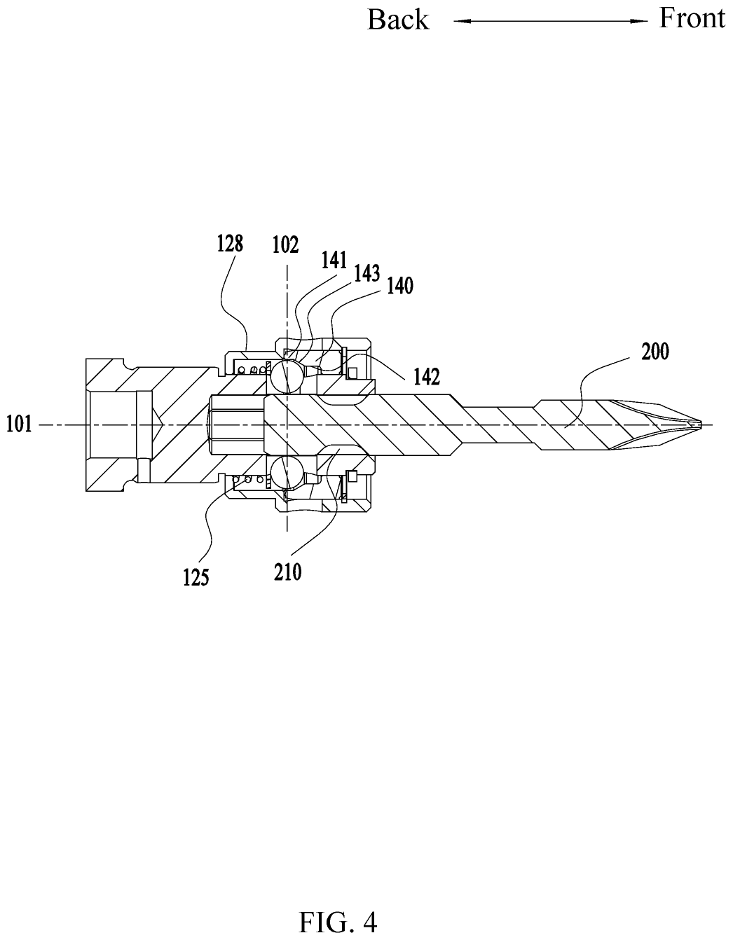

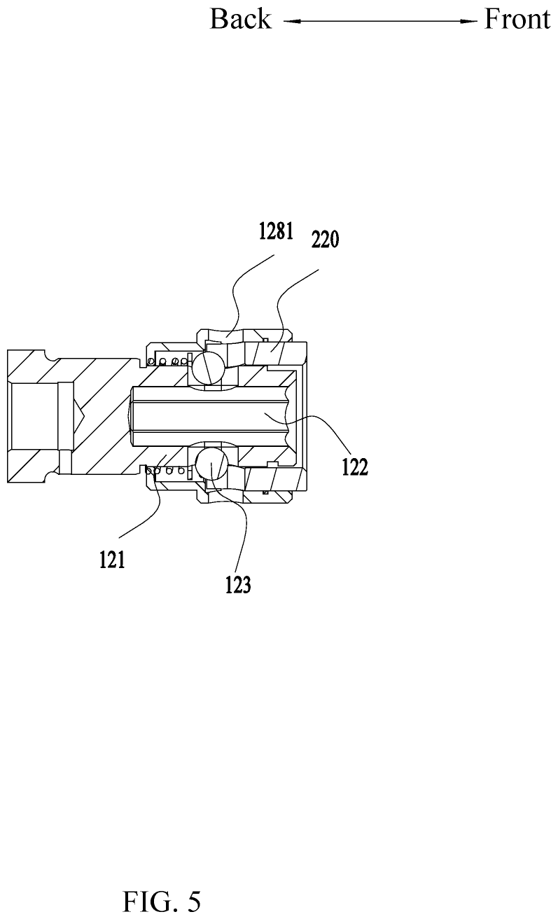

Referring to FIGS. 3 to 5, FIG. 3 is a structural view of the chuck assembly when the working component is locked to the power tool in the first example, where locking mechanism is in the locking position; FIG. 4 is a structural view of the chuck assembly when the working component is detached from the power tool in the first example, where the locking mechanism is disengaged from the locking position, that is, the locking mechanism is in the release position; and FIG. 5 is a structural view of the chuck assembly of the power tool in the first example during its manufacturing and assembly, where the working component is not mounted to the power tool. The working component 200 can be connected to the front of the housing. The biasing element 125 maintains the locking mechanism 123 in the locking position when the working component 200 is not mounted. When the user inserts the working component 200 into the connection cavity 122, the working component 200 presses the locking mechanism 123 and thus the locking mechanism 123 pushes the pushing member 160 and compresses the biasing element 125 backward so that the locking mechanism 123 enters the release position. The locking mechanism 123 can move along the second direction 102 so that the working component 200 can be completely inserted into the connection cavity 122. After the working component 200 is completely inserted into the connection cavity 122, the recess portion 210 is aligned with the locking mechanism 123, and the pushing member 160 pushes the locking mechanism 123 so that the locking mechanism 123 is in the locking position. At this time, the locking mechanism 123 is partially placed into the recess portion 210 so that the locking mechanism 123 can partially abut against the working component 200 and lock the working component 200 through the biasing force provided by the biasing element 125. When the working component 200 is removed, the operation member 128 can be operated to move forward with respect to the connection shaft 121, the driving assembly 12a and the limiting member 140 both move forward, and the first limiting portion 141 is aligned with the locking mechanism 123. When the working component 200 is pulled forward, the working component 200 presses the locking mechanism 123 to move along the second direction, and the locking mechanism 123 abuts against the second limiting portion 141 so that the locking mechanism 123 enters the release position. The locking mechanism 123 can move along the second direction 102 so that the working component 200 can be completely disengaged from the connection cavity 122.

The stopper member 180 is connected to the operation member 128. In this example, the stopper member 180 is a C-shaped circlip detachably connected to an inner sidewall of the operation member 128. The stopper member 180 is disposed along the first direction 101 on a side of the direction in which the driving assembly 12a moves out of the operation member 120. In this example, the stopper member 180 is disposed in front of the pushing member 160 along the first direction 101. More specifically, the stopper member 180 is disposed at a front end of the operation member to prevent the driving assembly 12a from moving out from inside the operation member 128 along the first direction 101. The stopper member 180 is provided so that the pushing member 160 and the biasing element 125 are confined in a gap 150 between the operation member 128 and the connection shaft 121. When the operation member 128 needs to be detached, the stopper member 180 is detached from the operation member 128, and then the limiting member 140 and the locking mechanism 123 are detached successively so that both the driving assembly 12a and the operation member 128 can be detached from the connection shaft 121. Thus, the operation member is detachably connected to the connection shaft to facilitate the maintenance of the chuck device. The connection shaft and the operation member can be detached and specific damaged parts can be replaced without replacing the entire chuck device, thereby reducing a maintenance cost.

The gap 150 exists between the operation member 128 and the connection shaft 121, and the limiting member 140, the pushing member 160, and the biasing element 125 are disposed in the gap 150.

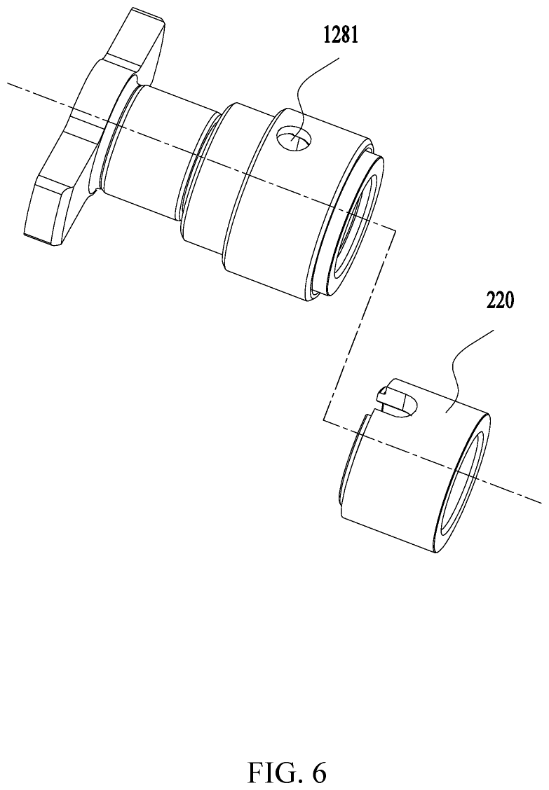

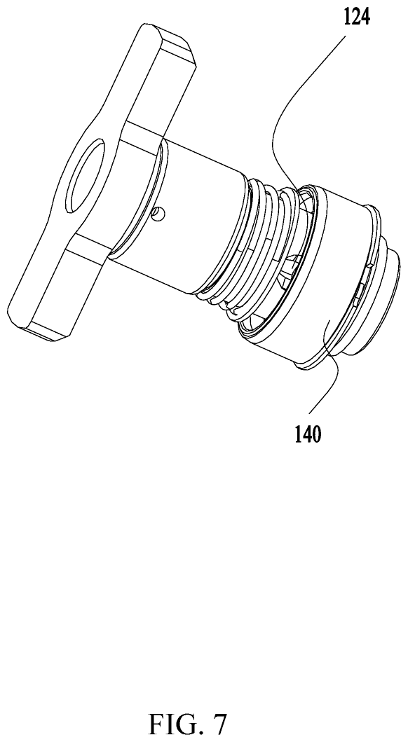

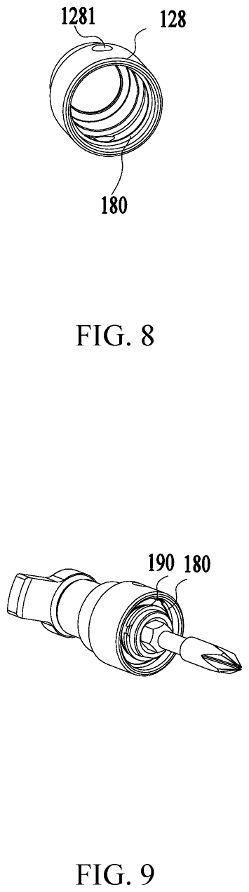

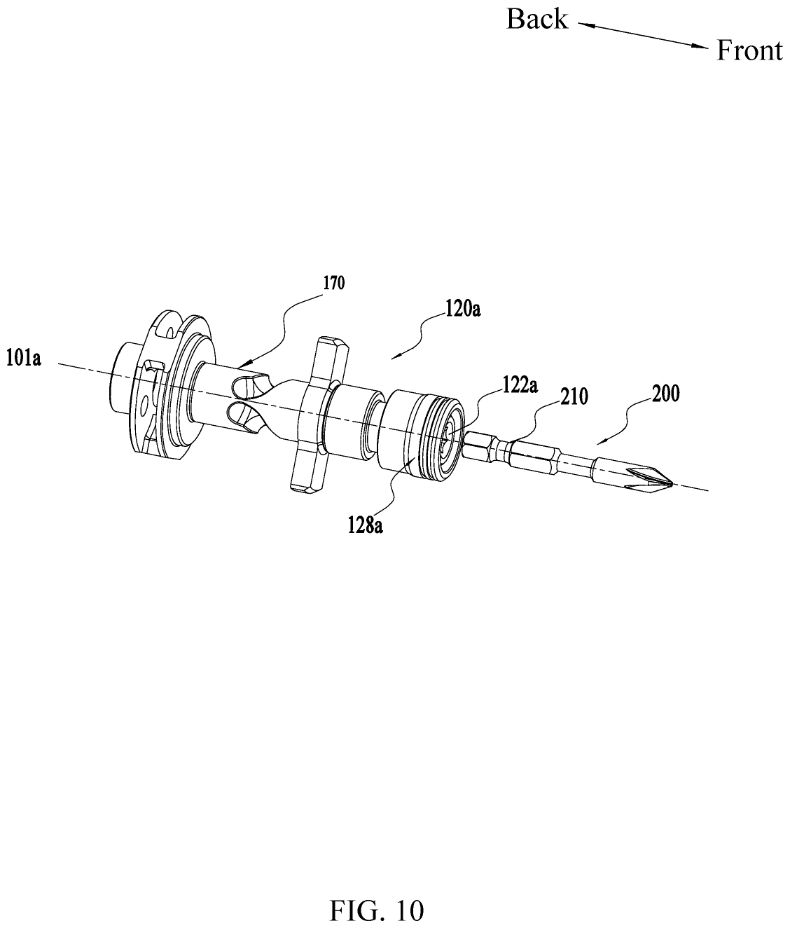

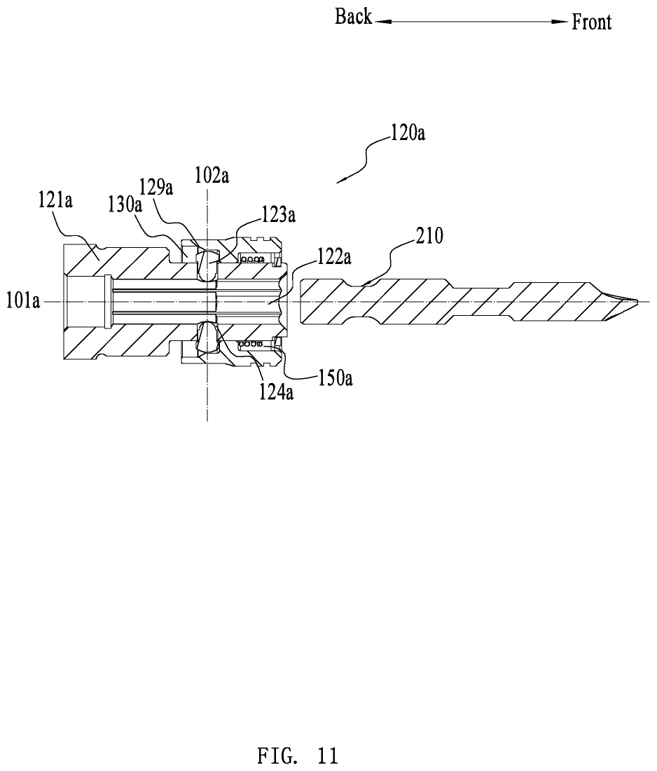

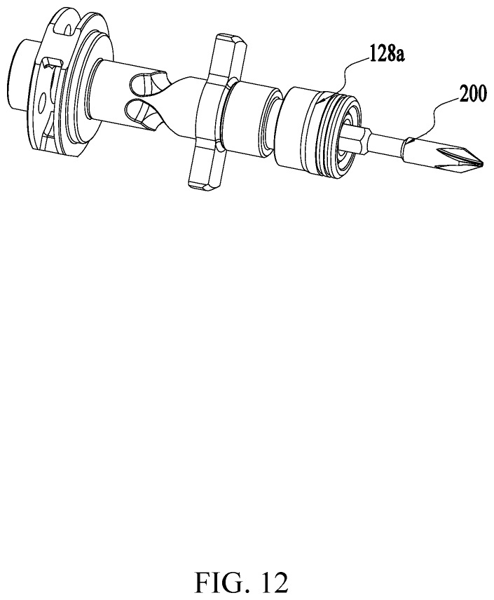

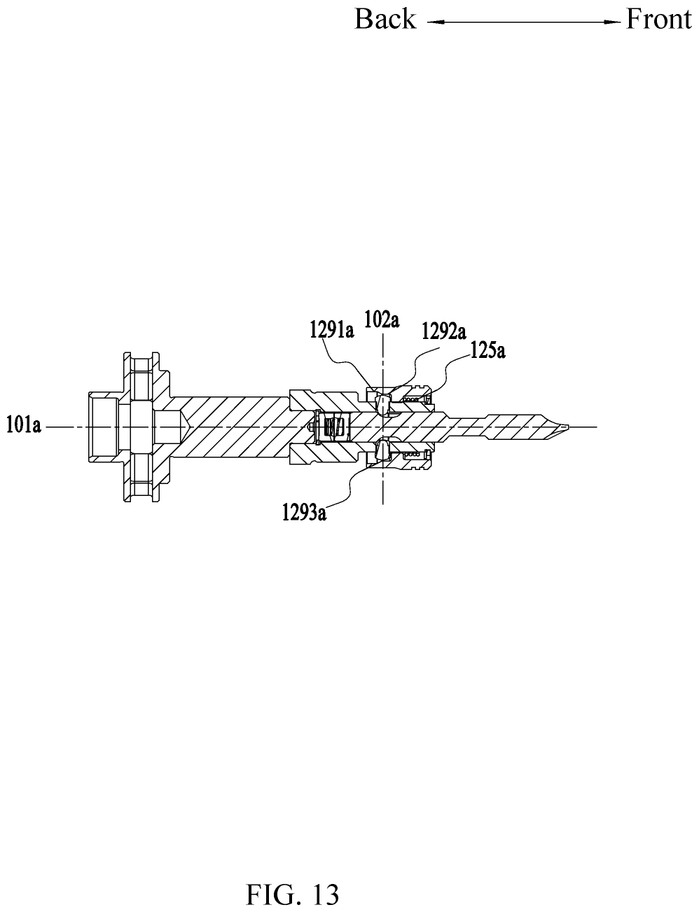

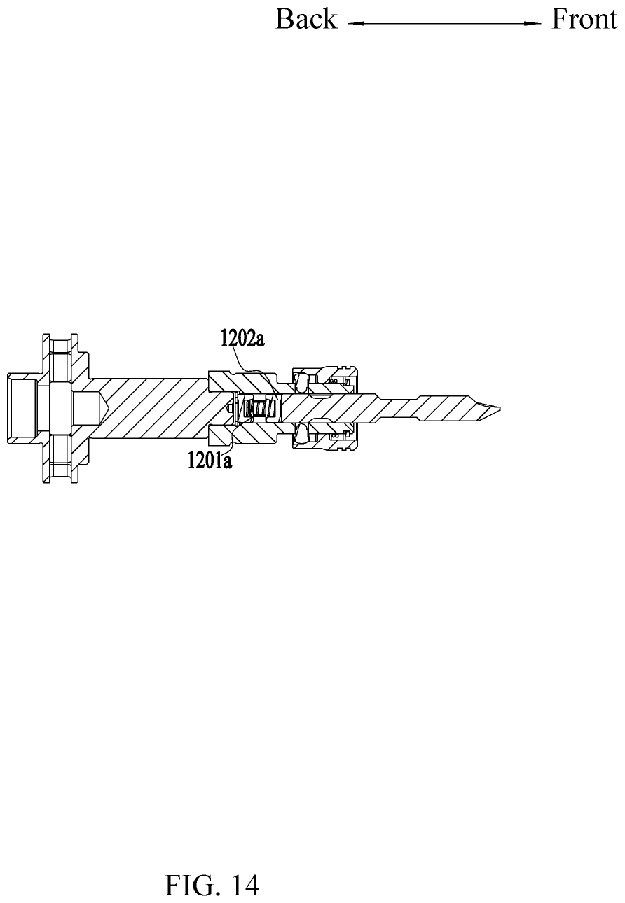

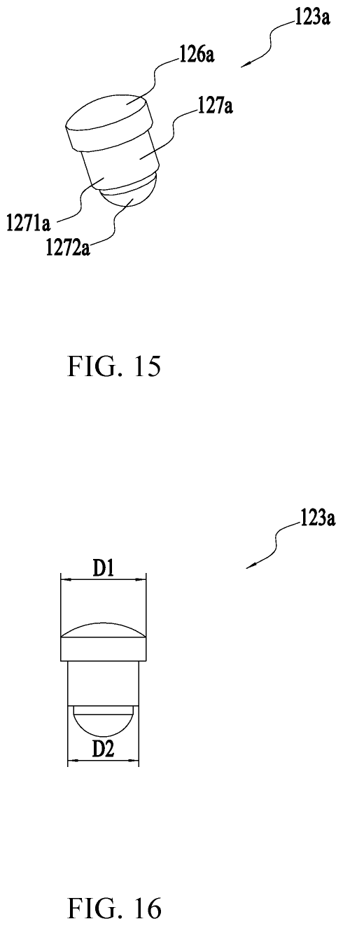

Referring to FIGS. 5 and 6, the operation member 128 includes a through hole 1281 for the locking mechanism 123 to pass through. The locking mechanism 123 is mounted to the operation member along a third direction 103, where the third direction 103 is perpendicular to or intersects with the first direction 101. When the chuck device 120 is assembled, the spherical locking mechanism 123 is placed into the gap 150 of the chuck device 120 via the through hole 1281. A fitting 220 is inserted into the gap 150 to abut against the biasing element and prevent the biasing element from pushing out the locking mechanism 123. The fitting 220 is pulled out and other elements such as the stopper member 180 are mounted. Here, the fitting 220 is configured to assist in the assembly of the chuck device 120. The through hole 1281 is provided to prevent the locking mechanism 123 from being placed into the gap 150 from an end of the gap 150 so that a height of the gap 150 may be less than a diameter of the locking mechanism 123, so as to reduce the size of the chuck device 120.

The limiting member 140 prevents the locking mechanism 123 from moving out from inside the operation member 128 along the third direction 103.

As an alternative example, a rubber ring surrounds the operation member 128 to cover the through hole 1281, the rubber ring may screen the through hole 1281 to a certain extent and serve as a decoration for beauty. When the user operates the operation member 128, the rubber ring makes the operation member 128 comfortable to grip.

In addition, it has been found that when the chuck device 120 is unlocked using the operation member 128, the user occasionally applies such an excessive force that the operation member 128 compresses the biasing element 125 excessively. Thus, a small-diameter position of the operation member 128 abuts against the locking mechanism 123, which makes the locking mechanism fail to be disengaged from the locking position and causes the chuck device 120 to be stuck. Referring to FIG. 9, the working component cannot be effectively separated. Therefore, a blocking element 190 disposed at an end of the connection shaft 121 is further added, where a distance exists between the blocking element 190 and an end surface of the operation member 128. The blocking element 190 is disposed at an end of the operation member 128, and the distance exists between the blocking element 190 and the end surface of the operation member 128. The connection shaft 121 is disposed in front of the housing. When the locking mechanism is in the locking position, the biasing element 125 pushes the pushing member 160 forward and pushes the operation member 128 backward. When the locking mechanism is disengaged from the locking position, the operation member 128 moves forward with respect to the connection shaft 121, and the blocking element 190 provided can prevent the operation member 128 from moving forward excessively and avoid the situation where the locking mechanism and the operation member 128 are stuck since a rear portion of the operation member 128 abuts against the locking mechanism. Thus, the distance between the blocking element and the end surface of the operation member 128 is a distance by which the operation member 128 can move when operated. The limiting member and the operation member 128 can be regarded as being fixedly connected to each other. The distance is provided between the blocking element and the end surface of the operation member 128, and thus a certain distance also exists between the limiting member and the blocking element.

Optionally, the blocking element 190 is a C-ring disposed at the end of the connection shaft 121, and the C-ring may be press-fitted onto the connection shaft 121 to facilitate assembly.

In this regard, a method for mounting the chuck device 120 is provided below. A. The operation member 128 is sleeved on the connection shaft 121. B. The driving assembly 12a is placed inside the operation member 128. C. Referring to FIGS. 5 and 6, the fitting 220 is placed between the operation member 128 and the connection shaft 121 to compress the biasing element 125. When the biasing element 125 is compressed, the locking mechanism 123 is placed between the operation member 128 and the connection shaft 121 via the through hole 1281 on the operation member 128, and then the fitting is taken out. The biasing element 125 and the pushing member 160 spring back and abut against the locking mechanism to prevent the locking mechanism from moving out of the mounting hole. D. The limiting member 140 is placed into the operation member 128, the driving assembly 12a is limited by the stopper member 180 on the inner wall of the operation member 128, and the blocking element 190 is mounted at the end of the connection shaft 121, where the distance exists between the blocking element 190 and the end surface of the operation member 128.

Optionally, step C further includes attracting the locking mechanism using a magnetic device so as to compress the biasing element 125. In this case, the locking mechanism is made of a magnetically attractable material.

In a second example, referring to FIGS. 10 to 16, a handheld power tool 100a includes a chuck assembly 120a for clamping and fixing a working component 200. Referring to FIGS. 10 and 11, the chuck assembly 120a includes a connection shaft 121a and locking mechanism 123a. The connection shaft 121a is connected to an output device 170 and forms a connection cavity 122a where the working component 200 is mounted. The locking mechanism 123a is disposed in the connection shaft 121a and have a locking position in which the working component 200 is locked. The working component 200 is inserted into the connection cavity 122a and then clamped and fixed by the chuck assembly 120a.

Referring to FIGS. 11 to 13, the chuck assembly 120a further includes a mounting hole 124a formed on the connection shaft 121a. The locking mechanism 123a is configured to partially pass through the mounting hole 124a and is movable along a second direction 102a with respect to the mounting hole 124a. The chuck assembly 120a further includes a biasing element 125a which can provide a biasing force for maintaining the locking mechanism 123a in locking position. The mounting hole 124a communicates with the connection cavity 122a, and the working component 200 can be placed into the connection cavity 122a. The locking mechanism 123a passing through the mounting hole 124a can partially abut against the working component 200 and lock the working component 200 through the biasing force provided by the biasing element 125a.

The chuck assembly 120a includes an operation member 128a sleeved on the connection shaft 121a. The operation member 128a can drive the biasing element 125a to release the clamping of the working component 200 through its movement. The operation member 128a includes a limiting portion 129a which surrounds a mounting cavity 130a for limiting the locking mechanism 123a, and the mounting cavity 130a is formed between the connection shaft 121a and the limiting portion 129a. The mounting hole 124a is exposed to an inside of the mounting cavity 130a and connect the mounting cavity 130a to the connection cavity 122a. The locking device 123a passes through the mounting hole 124a, and the locking device 123a includes a portion exposed to the mounting cavity 130a and a portion which can be exposed to the connection cavity 122a. In this example, a middle portion of the locking device 123a passes through the mounting hole 124a, and two ends of the locking device 123a may be in the mounting cavity 130a and the connecting cavity 122a, separately.

Referring to FIG. 13, the limiting portion 129a includes a first contact surface 1291a and a second contact surface 1292a. Optionally, the limiting portion 129a further includes an incline 1293a which connects the first contact surface 1291a to the second contact surface 1292a. In the second direction 102a, the first contact surface 1291a is away from the locking device 123a with respect to the second contact surface 1292a. The operation member 128a can be operated to move along a first direction 101a with respect to the connection shaft 121a. The operation member 128a drives the limiting portion 129a to move along the first direction 101a, thereby changing a contact surface of the limiting portion 129a aligned with the locking device 123a. Thus, a projection of the first contact surface 1291a, the second contact surface 1292a, or the incline 1293a and a projection of the locking device 123a in a radial direction of the first direction 101a partially overlap each other. The incline 1293a is used for transition between the first contact surface 1291a and the second contact surface 1292a so that the locking device 123a can slide smoothly from a state of being in contact with the first contact surface 1291a to a state of being in contact with the second contact surface 1292a.

Referring to FIGS. 15 and 16, the locking device 123a includes a stopper member 126a and a body portion 127a, where a diameter D1 of the stopper member 126a in a radial direction of the second direction 102a is greater than a diameter D2 of the body portion 127a in the radial direction of the second direction 102a. The body portion 127a includes a first body 1271a and a second body 1272a, where the first body 1271a is mainly in the mounting hole 124a and connects the stopper member 126a to the second body 1272a, and the second body 1272a is the portion of the locking device 123a exposed to the connection cavity 122a and can abut against the working component 200 placed into the connection cavity 122a to limit the working component 200. The stopper member 126a is in the mounting cavity 130a and can abut against the first contact surface 1291a, the second contact surface 1292a, and the incline 1293a of the limiting portion 129a. The diameter of the stopper member 126a in the radial direction of the second direction 102a is greater than a diameter of the mounting hole 124a in the radial direction of the second direction 102a. Thus, the stopper member 126a will not pass through the mounting hole 124a, so as to prevent the locking device 123a from moving out of the mounting hole 124a toward the connection cavity 122a. In addition, the limiting portion 129a limits the locking device 123a to prevent the locking device 123a from moving out of the mounting hole 124a toward the mounting cavity 130a.

The working component 200 includes recess portion 210. The locking mechanism 123a is partially inserted into the recess portion 210 when the working component 200 is mounted to the chuck assembly 120a. When the locking device 123a is aligned with the first contact surface 1291a, the locking device 123a is in a release position. Since the first contact surface 1291a is away from the locking device 123a with respect to the second contact surface 1292a, the locking device 123a can move along the second direction 102a with respect to the connection shaft 121a, thereby releasing the working component 200 from the limitation by the locking device 123a. When the locking device 123a is aligned with the second contact surface 1292a, the locking device 123a is in the locking position, the stopper member 126a abuts against the second contact surface 1292a, and the second body 1272a is engaged with the recess portion 210. The position of the locking device 123a is limited by the limiting portion 129a, and the working component 200 is connected by the locking device 123a. Two or more locking mechanisms 123a may be provided to enhance the stability of clamping the working component 200.

Referring to FIGS. 11, 13, and 14, FIG. 11 is a structural view of the chuck assembly when the working component is not mounted to the power tool in the second example; FIG. 13 is a structural view of the chuck assembly when the working component is locked to the power tool in the second example, where the locking mechanism is in the locking position; and FIG. 14 is a sectional view of the chuck assembly when the working component is unlocked from the power tool in the second example, where the locking mechanism is in the release position. The working component 200 can be connected to the front of the housing, and the operation member 128a can be operated to move forward with respect to the connection shaft 121a so that the locking device 123a is disengaged from the locking position and moves to the release position. The biasing element 125a connects the operation member 128a to the connection shaft 121a. The biasing element 125a is disposed in a gap 150a between the operation member 128a and the connection shaft 121a. The biasing element 125a biases the operation member 128a so that the second contact surface 1292a is aligned with the locking device 123a. Thus, the locking device 123a is maintained in the locking position through the biasing force provided by the biasing element 125a. The user may push the operation member 128a forward such that the operation member 128a compresses the biasing element 125a, so as to change the contact surface aligned with the locking device 123a. When the working component 200 is not mounted, the biasing element 125a maintains the locking device 123a in the locking position. The user inserts the working component 200 into the connection cavity 122a, and the working component 200 presses the locking device 123a. Thus, the locking device 123a pushes the operation member 128a and compresses the biasing element 125a forward so that the locking device 123a enters the release position. The locking device 123a can move along the second direction 102a so that the working component 200 can be completely inserted into the connection cavity 122a. After the working component 200 is completely inserted into the connection cavity 122a, the locking device 123a is partially placed into the recess portion 210 so that the locking device 123a no longer pushes the operation member 128a. The operation member 128a returns to an original position under the action of the biasing element 125a so that the locking device 123a is in the locking position. In this case, the locking device 123a is partially placed into the recess portion 210 and limited by the operation member 128a so that the chuck assembly 120a can connect the working component 200.

Optionally, the body portion 127a is a cylinder and mates with the stopper member so that the diameter of the mounting hole 124a can be unchanged, which can simplify a manufacturing process and reduce a manufacturing cost.

An upper surface of the stopper member 126a is an arcuate curved surface so that a center of the upper surface of the stopper member 126a is higher than other positions in the second direction 102a. The arcuate curved surface can mate with the first contact surface 1291a, the second contact surface 1292a, and the incline 1293a so that the stopper member 126a can smoothly slide along the first contact surface 1291a, the second contact surface 1292a, and the incline 1293a, thereby improving the user's feeling.

Referring to FIG. 14, the chuck assembly 120a further includes an elastic member 1201a and a pushing block 1202a. The pushing block 1202a can abut against the working component 200. When the locking device 123a leaves the locking position, the elastic member 1201a pushes the pushing block 1202a so that the working component 200 is ejected with respect to the connection cavity 122a. Thus, when the user needs to release the limitation to the working component 200, the user only needs to push the operation member 128a such that the locking mechanism returns to the release position, the elastic member 1201a acts on the pushing block 1202a, and the pushing block 1202a is automatically pushed to eject the working component 200. Thus, when the user needs to mount and connect the working component 200, the user only needs to push the working component 200 into the connection cavity 122a, which can be completed with a single hand, thereby facilitating the user's operation. When the user needs to detach the working component 200, the user only needs to push the operation member 128a such that the locking mechanism 123a return to the release position, which can also be completed with a single hand, thereby facilitating the user's operation. The connection shaft 121a is hollow, and the elastic member 1201a and the pushing block 1202a are disposed in the connection shaft 121a, thereby reducing the volume of a quick clamping device.

In the preceding example, the limiting portion 129a is formed on the operation member 128a, that is, the operation member 128a and the limiting portion 129a are integrally formed. Optionally, the chuck assembly 120a includes the operation member 128a and the limiting portion 129a which are connected to each other. The operation member 128a is sleeved on the connection shaft 121a, the limiting portion 129a includes a top block which can push the locking device 123a into the locking position, and the biasing element 125a connects the top block and the operation member 128a.

What is claimed is:

1. A power tool, comprising:
a housing;
an output device capable of driving a working component; and
a chuck device for clamping the working component;
wherein the chuck device comprises:
a locking mechanism having a locking position in which the working component is locked;
an operation member operable to allow the locking mechanism to leave the locking position;
a connection shaft for connecting the operation member to the output device, wherein the operation member is detachably connected to the connection shaft;
a driving assembly disposed inside the operation member, moving along a first direction with respect to the connection shaft, and capable of driving the locking mechanism to be in the locking position; and
a stopper member connected to the operation member and configured to limit the driving assembly and prevent the driving assembly from moving out from inside the operation member along the first direction.

2. The power tool according to claim 1, wherein the driving assembly comprises a biasing element and a pushing member, the pushing member abuts against the locking mechanism, and the biasing element is capable of providing a biasing force for pushing the locking mechanism to be in the locking position and maintaining the locking mechanism in the locking position.

3. The power tool according to claim 1, wherein the chuck device further comprises a blocking element disposed at an end of the operation member, a distance exists between the blocking element and an end surface of the operation member, and the blocking element restricts the operation member from moving forward by a distance when the locking mechanism is disengaged from the locking position.

4. The power tool according to claim 1, wherein the locking mechanism is disposed inside the operation member.

5. The power tool according to claim 4, wherein the operation member comprises a through hole for the locking mechanism to pass through to enter the interior of the operating member.

6. The power tool according to claim 5, wherein the locking mechanism comprises spheres.

7. The power tool according to claim 4, wherein the chuck device further comprises a limiting member, the limiting member comprises a first limiting portion and a second limiting portion, the second limiting portion abuts against the locking mechanism when the locking mechanism is in the locking position, and the first limiting portion allows the locking mechanism to leave the locking position when the locking mechanism is disengaged from the locking position.

8. The power tool according to claim 7, wherein the limiting member further comprises an incline which connects the first limiting portion to the second limiting portion.

9. The power tool according to claim 7, wherein the operation member comprises a through hole for the locking mechanism to pass through to enter the interior of the operating member along a third direction, and the limiting member prevents the locking mechanism from moving out from inside the operation member along the third direction.

10. The power tool according to claim 1, wherein the connection shaft forms a connection cavity where the working component is mounted, and the connection cavity extends along an axial direction of the connection shaft.

11. The power tool according to claim 10, wherein the connection shaft forms a mounting hole communicating with the connection cavity, and the locking mechanism is configured to partially pass through the mounting hole and is movable along a second direction with respect to the mounting hole.

12. The power tool according to claim 11, wherein the mounting hole extends along the first direction and the locking mechanism is configured to slide in the mounting hole along the first direction.

13. The power tool according to claim 1, wherein a gap exists between the operation member and the connection shaft, and the driving assembly is disposed in the gap.

14. The power tool according to claim 13, wherein a height of the gap is less than a diameter of the locking mechanism.

15. The power tool according to claim 1, wherein the working component comprises a recess portion and the locking mechanism is partially inserted into the recess portion when the working component is mounted to the chuck device.

16. A power tool, comprising:
a housing;
an output device capable of driving a working component; and
a chuck device for clamping the working component;
wherein the chuck device comprises:
a locking mechanism having a locking position in which the working component is locked;
an operation member operable to allow the locking mechanism to leave the locking position; and
a connection shaft for connecting the output device to the operation member, wherein the operation member is detachably connected to the connection shaft.

17. A power tool, comprising:
a housing;
an output device capable of driving a working component; and
a chuck device for clamping the working component;
wherein the chuck device comprises:
a locking mechanism having a locking position in which the working component is locked;
an operation member operable to allow the locking mechanism to leave the locking position;
a connection shaft for connecting the output device to the operation member, wherein the locking mechanism connects the connection shaft to the operation member;
a driving assembly disposed inside the operation member and used for driving the locking mechanism to be in the locking position; and
a stopper member detachably connected to the operation member and configured to limit the driving assembly and prevent the driving assembly from moving out from inside the operation member.

18. The power tool according to claim 17, wherein the stopper member is a C-ring connected to an inner wall of the operation member.

19. The power tool according to claim 18, wherein the stopper member moves synchronously with the operation member with respect to the connection shaft.

20. The power tool according to claim 17, wherein the chuck device further comprises a blocking element mounted at an end of the connection shaft, the blocking element is detachably connected to the connection shaft, a distance exists between the blocking element and an end surface of the operation member, and the blocking element limits a moving distance of the stopper member.
